(19) United States
(12) Patent Application Publication
(10) Pub. No.: US 2026/0053200 A1
(43) Pub. Date: Feb. 26, 2026

(54) ELECTRONIC ATOMIZATION APPARATUS AND CONTROL METHOD THEREFOR

(71) Applicant: SHENZHEN FIRST UNION TECHNOLOGY CO., LTD., Shenzhen, Guangdong Provine (CN)

(72) Inventors: Linjian HUANG, Shenzhen, Guangdong Provine (CN); Zhongli XU, Shenzhen, Guangdong Provine (CN); Yonghai LI, Shenzhen, Guangdong Provine (CN)

(73) Assignee: SHENZHEN FIRST UNION TECHNOLOGY CO., LTD., Shenzhen, Guangdong Provine (CN)

(21) Appl. No.: 19/103,244

(22) PCT Filed: Sep. 19, 2023
(86) PCT No.: PCT/CN2023/119640

§ 371 Date: Feb. 12, 2025

(30) Foreign Application Priority Data
Sep. 19, 2022 (CN) 202211137534.X

(51) Int. Cl. A24F 40/57; A24F 40/10; A24F 40/465; H05B 6/10

(52) U.S. Cl. CPC A24F 40/57; A24F 40/10; A24F 40/465; H05B 6/108

(57) ABSTRACT

An electronic atomization apparatus and a control method therefor. The electronic atomization apparatus comprises: a cell, an inverter, a susceptor, and a controller, which is configured to control the cell to supply power to the inverter within at least one vaping period, wherein the vaping period is continuous and comprises a first duration and a second duration; within the first duration, a power supply voltage of the inverter is controlled to be a first operating voltage, the first operating voltage being greater than an output voltage of the cell; and within the second duration, the power supply voltage of the inverter is controlled to be a second operating voltage, the second operating voltage being lower than the first operating voltage. In this way, an inhalable aerosol can be quickly generated within the first duration, and energy consumption can be effectively saved on on the whole.

### CROSS-REFERENCE TO RELATED APPLICATIONS

This application claims priority to Chinese Patent Application No. 202211137534.X, filed with the China National Intellectual Property Administration on Sep. 19, 2022 and entitled “ELECTRONIC ATOMIZATION APPARATUS AND CONTROL METHOD THEREFOR”, which is incorporated herein by reference in its entirety.

### TECHNICAL FIELD

This application relates to the field of electronic atomization technologies, and in particular, to an electronic atomization apparatus and a control method therefor.

### BACKGROUND

An electronic atomization apparatus is an electronic product that generates smoke for a user to inhale by heating e-liquid, and generally includes two parts: an atomizer and a power supply assembly. The atomizer internally stores the e-liquid and is provided with an atomizing core for heating the e-liquid. The power supply assembly includes a battery and a circuit board.

At present, a typical atomizing core is of a ceramic core structure in which a heating wire and porous ceramics are integrally formed. The power supply assembly may supply power to the heating wire to cause the heating wire to generate heat, so as to generate high heat to heat the e-liquid. The atomizing core has the problems of low heating efficiency and slow speed of generating an inhalable aerosol.

### SUMMARY

This application aims to provide an electronic atomization apparatus and a control method therefor, aiming to solve the problems of low heating efficiency and slow speed of generating an inhalable aerosol in an existing atomizing core.

An aspect of this application provides an electronic atomization apparatus, including:
a battery cell, configured to provide power;
an inverter, configured to generate a changing magnetic field; and
a susceptor, configured to be penetrated by the changing magnetic field to generate heat, so as to heat a liquid substrate to generate an aerosol; and
a controller, configured to control the battery cell to provide power to the inverter within at least one puff period, where the puff period is continuous and includes first duration and second duration; control a power supply voltage of the inverter to be a first operating voltage within the first duration, where the first operating voltage is greater than an output voltage of the battery cell; and control the power supply voltage of the inverter to be a second operating voltage within the second duration, where the second operating voltage is less than the first operating voltage.

Another aspect of this application provides a control method for an electronic atomization apparatus, where the electronic atomization apparatus includes:
a battery cell, configured to provide power;
an inverter, configured to generate a changing magnetic field; and
a susceptor, configured to be penetrated by the changing magnetic field to generate heat, so as to heat a liquid substrate to generate an aerosol; and
the method includes:
controlling the battery cell to provide power to the inverter within at least one puff period, where the puff period is continuous and includes first duration and second duration;
controlling a power supply voltage of the inverter to be a first operating voltage within the first duration, where the first operating voltage is greater than an output voltage of the battery cell; and
controlling the power supply voltage of the inverter to be a second operating voltage within the second duration, where the second operating voltage is less than the first operating voltage.

In the electronic atomization apparatus and the control method therefor, the power supply voltage of the inverter is controlled to be the first operating voltage within the first duration, and the power supply voltage of the inverter is controlled to be less than the first operating voltage within the second duration, so that an inhalable aerosol can be quickly generated within the first duration, and energy consumption can be effectively reduced on the whole.

### BRIEF DESCRIPTION OF THE DRAWINGS

One or more embodiments are exemplarily described with reference to corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization apparatus according to an implementation of this application;

FIG. 2 is a schematic diagram of a switching circuit and a resonant circuit according to an implementation of this application;

FIG. 3 is a schematic diagram of a booster circuit according to an implementation of this application;

FIG. 4 is a schematic diagram of power supply for one puff according to an implementation of this application; and

FIG. 5 is a schematic diagram of a control method for an electronic atomization apparatus according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are only used for an illustrative purpose.

Unless otherwise defined, meanings of all technical and scientific terms used in this specification are the same as those usually understood by a person skilled in the art to which this application belongs. The terms used in this specification of this application are merely intended to describe objectives of the specific implementations, and are not intended to limit this application. A term “and/or” used in this specification includes any or all combinations of one or more related listed items.

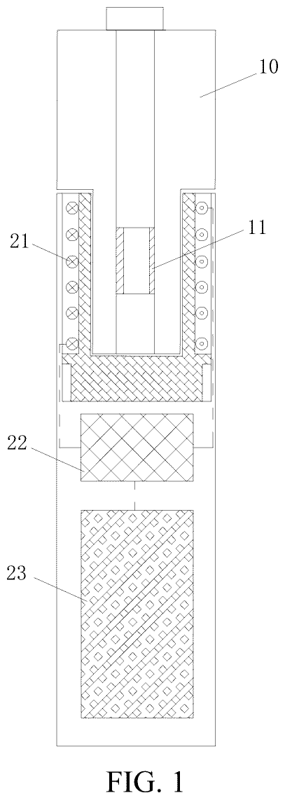

FIG. 1 is a schematic diagram of an electronic atomization apparatus according to an implementation of this application.

As shown in FIG. 1, an electronic atomization apparatus 100 includes an atomizer 10 and a power supply assembly 20. In an example, the atomizer 10 is removably connected to the power supply assembly 20, and the atomizer 10 may be in snap-fit connection, magnetic connection, or the like to the power supply assembly 20. In another example, it is also feasible that the atomizer 10 and the power supply assembly 20 are integrally formed.

The atomizer 10 includes a susceptor 11 and a liquid storage chamber (not shown). The liquid storage chamber is configured to store an atomizable liquid substrate. The susceptor 11 is configured to be inductively coupled to the inductor 21, and generate heat when penetrated by a changing magnetic field, to heat the liquid substrate, so as to generate an aerosol for inhalation.

In an example, the atomizer 10 includes a carrier or container carrying the liquid substrate, and the susceptor may be combined in the carrier or container. For example, the container carrying the liquid substrate has a liquid storage chamber, and the susceptor is mounted in the container. A position of the susceptor in the container is fixed, facilitating more efficient electromagnetic coupling to the inductor when the atomizer matches the power supply assembly. The susceptor may be in direct contact with the liquid substrate in the liquid storage chamber, or the susceptor may be in indirect contact with the liquid substrate. For example, a wicking material is arranged between the susceptor and the liquid storage chamber. The wicking material is used to transfer the liquid substrate to the susceptor. An optional wicking material includes a porous material or a fiber material. In some other examples, the susceptor is in non-contact with the liquid substrate. For example, the susceptor is close to the carrier holding the liquid substrate.

The liquid substrate preferably includes a tobacco-containing material. The tobacco-containing material includes a volatile tobacco aroma compound released from the liquid substrate when being heated. Alternatively or additionally, the liquid substrate may include a non-tobacco material. The liquid substrate may include water, ethanol or another solvent, a plant extract, a nicotine solution, and a natural or artificial flavoring agent. Preferably, the liquid substrate further includes an aerosol-forming agent. Examples of a suitable aerosol-forming agent are glycerol and propylene glycol.

Generally, the susceptor 11 may be made of at least one of the following materials: aluminum, iron, nickel, copper, bronze, cobalt, ordinary carbon steel, stainless steel, ferritic stainless steel, martensitic stainless steel, or austenitic stainless steel.

Further, the atomizer 10 further includes a liquid transfer unit. The liquid transfer unit may be made of, for example, a cotton fiber, a metal fiber, a ceramic fiber, a glass fiber, a porous ceramic, or the like. The liquid substrate stored in the liquid storage chamber may be transferred to the susceptor 11 through a capillary action.

The power supply assembly 20 includes an inductor 21, a circuit 22, and a battery cell 23.

The inductor 21 generates a changing magnetic field under an alternating current. The inductor 21 includes, but is not limited to, an induction coil.

The battery cell 23 provides power for operating the electronic atomization apparatus 100. The battery cell 23 may be a rechargeable battery cell or a disposable battery cell.

The circuit 22 may control overall operations of the electronic atomization apparatus 100. The circuit 22 not only controls operations of the battery cell 23 and the inductor 21, but also controls operations of other elements in the electronic atomization apparatus 100.

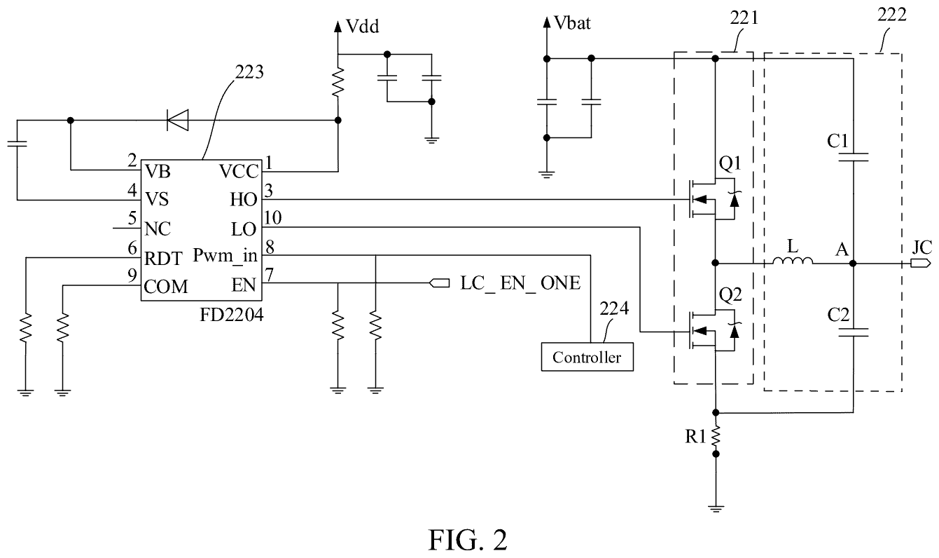

FIG. 2 is a schematic diagram of a basic assembly according to an embodiment of the circuit 22. The circuit 22 includes:

an inverter, including a switching circuit 221 and a resonant circuit 222.

The switching circuit 221 is a half-bridge circuit composed of transistors. The transistor includes, but is not limited to, an IGBT, a MOS, or the like. As shown in the figure, the half-bridge circuit includes a switching transistor Q1 and a switching transistor Q2, which are configured to enable the resonant circuit 222 to generate resonance by means of alternate on-off switching.

The resonant circuit 222 is composed of an inductor 21 (shown by L in the figure), a first capacitor C1, and a second capacitor C2. The resonant circuit 222 is configured to form, during resonance, an alternating current flowing through the inductor L, so that the inductor L generates an alternating magnetic field to induce the susceptor 11 to heat up.

A driver 223 is configured to control the switching transistor Q1 and the switching transistor Q2 of the switching circuit 221 to be alternately turned on and off based on a control signal of the controller. The controller may alternatively be part of the circuit 22, and is preferably an MCU.

As an example, as shown in FIG. 2, the driver 223 is a commonly used FD2204 model switching transistor driver, which is controlled by a controller 224 in a PWM manner. Based on a pulse width of PWM, high/low levels are alternately emitted from a 3^{rd} I/O port and a 10^{th} I/O port respectively, to drive an on time of the switching transistor Q1 and the switching transistor Q2, so as to control the resonant circuit 222 to generate resonance.

In connection, the switching transistor Q1 is connected in series to the switching transistor Q2 to form a first branch, and the first capacitor C1 is connected in series to the second capacitor C2 to form a second branch. One end of the inductor L is electrically connected between the switching transistor Q1 and the switching transistor Q2, and the other end of the inductor Lis electrically connected between the first capacitor C1 and the second capacitor C2.

Specifically, a first end of the first capacitor C1 is connected to a positive electrode of the battery cell 23, and a second end thereof is connected to a first end of the second capacitor C2; a second end of the second capacitor C2 is grounded through a resistor R1; and a first end of the switching transistor Q1 is connected to the positive electrode of the battery cell 23, a second end thereof is connected to a first end of the switching transistor Q2, and a second end of the switching transistor Q2 is grounded through the resistor R1. Certainly, control ends of the switching transistor Q1 and the switching transistor Q2 are both connected to the driver 223, so as to be turned on and off under driving of the driver 223. A first end of the inductor L is connected to the second end of the switching transistor Q1, and a second end of the inductor L is connected to the second end of the first capacitor C1.

In terms of hardware selection of a resonant device, withstand voltage values of the first capacitor C1, the second capacitor C2, the switching transistor Q1, and the switching transistor Q2 are far greater than an output voltage value of the battery cell 23. For example, in a usual implementation, an output voltage of the battery cell 23 used is basically about 4 V, while withstand voltage values of the first capacitor C1, the second capacitor C2, the switching transistor Q1 and the switching transistor Q2 are within 100 V.

In the resonant circuit 222 with the above structure, when the switching transistor Q1 and the switching transistor Q2 are switched, a connection state between the first capacitor C1 and the inductor L and a connection state between the second capacitor C2 and the inductor L are changed. When the switching transistor Q1 is turned on and the switching transistor Q2 is turned off, the first capacitor C1 and the inductor L jointly form a closed LC series loop, while the second capacitor C2 and the inductor L form an LC series loop with two ends connected to the positive electrode and a negative electrode of the battery cell 23 respectively. When the switching transistor Q1 is turned off and the switching transistor Q2 is turned on, a loop formed is opposite to that in the above state, and the first capacitor C1 and the inductor L form an LC series loop with two ends connected to the positive electrode and the negative electrode of the battery cell 23 respectively, while the second capacitor C2 and the inductor L jointly form a closed LC series loop. In different states, both the first capacitor C1 and the second capacitor C2 each can form an LC series loop with the inductor L. However, during oscillation of the respective LC series loops, generated currents flowing through the inductors are the same in direction and cycle, and then jointly form an alternating current that flows through the inductor L.

When the controller 224 drives the switching transistor Q1 and the switching transistor Q2 to be alternately turned on and off through the driver 223, the inductor L, the first capacitor C1 and the second capacitor C2 operate in a resonant state, and a central resonant point A generates sinusoidal oscillation, with a voltage amplitude being Q times as large as Vin, where Q is a quality factor of the inductor L, the first capacitor C1 and the second capacitor C2, and Vin is an input voltage or a power supply voltage of the switching circuit 221. When Vin is constant, a larger Q value indicates a higher amplitude of a resonant voltage at the point A, a greater magnetic induction intensity β of coupling to the susceptor 11, a higher induced electromotive force received by the susceptor 11, and a higher heating speed. A resonant frequency can improve a quality factor of a resonant loop. Under constant Vin, a higher resonant frequency indicates a greater Q value. However, a higher frequency indicates a larger loss of the switching transistor, lower efficiency of an entire system, and shorter duration of power supply from the battery cell 23. As an atomizer product that can be implemented in batches, the atomizer is generally used as a consumable containing a liquid substrate, and there are certain limitations on a material, a volume, a shape and mass of the susceptor in the atomizer. Based on these limitations, to match a shape and arrangement of a coil of the inductor, an appropriate and optional resonant frequency range needs to be set for the resonant circuit of the inverter. As an example of interest, a preferred resonant frequency ranges from 800 KHz to 2 MHz. When applied to the atomizer product containing a liquid substrate, the determined resonant frequency may be selected within this range and matched based on factors such as a specific shape and dimension of the susceptor. The inverter operates at one or more resonant frequencies selected from the foregoing range, which can not only ensure the heating speed of the susceptor and meet requirements of TPM of an aerosol generated by atomization of a conventional liquid substrate, but also appropriately reduce a circuit loss of the resonant circuit such as the switching transistors and improve power supply endurance.

Vin is positively correlated with the resonant voltage at the point A. That is, when Vin is larger, the resonant voltage at the point A is also larger. The circuit 22 may further include a booster circuit for boosting a voltage of the battery cell to increase the voltage value of Vin.

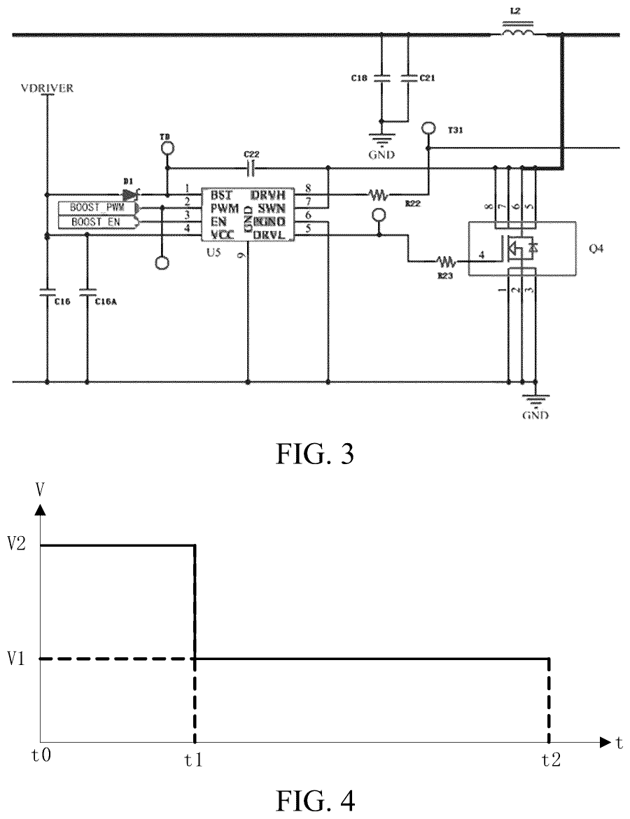

The booster circuit may be a common boost circuit. As a specific example, as shown in FIG. 3, the booster circuit includes a switching transistor Q4 and an energy storage device L2. A driver U5 drives the switching transistor Q4 to be turned on or off under a control signal of the controller, to output a boosted voltage. It should be noted that, only a schematic diagram of part of the circuit is provided in FIG. 3, and a pre-stage or post-stage circuit is not shown.

In an example, to quickly generate an inhalable aerosol and effectively reduce energy consumption on the whole, based on activation of the electronic atomization apparatus, the controller controls the battery cell to output power to the inverter during at least one puff period. The puff period is continuous, that is, a process of smoking by a user includes a plurality of puff periods at intervals, and each puff period may include first duration and second duration. The controller may be configured to control a power supply voltage of the inverter to be a first operating voltage within the first duration of one puff, where the first operating voltage is greater than a voltage of the battery cell (an output voltage of the battery cell); and control the power supply voltage of the inverter to be a second operating voltage within the second duration of the one puff, where the second operating voltage is less than the first operating voltage.

In some examples, the first duration starts from an activation time of the electronic atomization apparatus, and the first duration and the second duration are consecutive or not. In some examples, each puff period is not limited to being composed of the first duration and the second duration, and may further include, for example, third duration. The operating voltage of the inverter within the third duration may be less than the second operating voltage, or greater than the second operating voltage and less than the first operating voltage.

Generally, a quantity of puffs or times of puffing on the electronic atomization apparatus 100 that can be performed varies with the liquid substrate stored in the liquid storage chamber. If a quantity of puffs on the electronic atomization apparatus 100 that can be performed is N, one puff may be any one of the N puffs or a puff for once. Preferably, each puff may be controlled in the foregoing manner.

In a preferred implementation, a starting time of the first duration is a time at which a puff indication signal is obtained; and a starting time of the second duration is an end time of the first duration, and an end time of the second duration is an end time of the one puff.

In this embodiment, the puff indication signal may be an indication signal generated by a button or an indication signal generated by a sensor. Preferably, the electronic atomization apparatus 100 may further include an airflow sensor, such as a microphone, for detecting whether the electronic atomization apparatus is puffed 100 to generate a puff indication signal.

In a further preferred implementation, the second duration is greater than the first duration. The first duration ranges from 0.2 s to 1 s; preferably, the first duration ranges from 0.3 s to 1 s; and further preferably, the first duration ranges from 0.3 s to 0.8 s.

In this way, within short duration of one puff, an inhalable aerosol is quickly generated, which can effectively reduce energy consumption on the whole and improve endurance of the battery cell.

In terms of control, within the first duration, the booster circuit is controlled to operate to boost the voltage of the battery cell and output a higher first operating voltage. Within the second duration, the booster circuit may be controlled not to operate to cause the power supply voltage of the inverter to be the voltage of the battery cell or to control the power supply voltage of the inverter to be close to the voltage of the battery cell. For example, the booster circuit may be controlled to operate to output a second operating voltage slightly greater than the voltage of the battery cell.

As shown in FIG. 4, t0-t2 is duration of one puff. Generally, the duration of one puff is approximately 3 s. t0-t1 is first duration of one puff, and the first duration may be 0.5 s. t1-t2 is second duration of one puff, and the second duration may be 2.5 s. The voltage Vin may be controlled to be 8.5 V within the first duration. Within the first duration, the voltage Vin may be controlled to be the voltage of the battery cell, for example, 4 V. During each puff period, that is, the first duration and the second duration, a resonant frequency of the inverter may be unchanged. For example, the resonant frequency of the inverter may be 2 MHz. In some examples, during each puff period, the resonant frequency of the inverter may be changed. For example, within the first duration, the controller controls the resonant frequency of the inverter to be greater than the resonant frequency within the second duration, which is beneficial to increasing the speed of generating an aerosol by the electronic atomization apparatus within the first duration of each puff.

In other examples, within duration of one puff other than the first duration, the power supply voltage of the inverter is controlled to be less than the first operating voltage.

Still taking FIG. 4 as an example, during a t0-t1 period, the voltage Vin may be controlled to be 8.5 V; and during a t1-t2 period, the voltage Vin may be controlled to be gradually reduced to the voltage of the battery cell, for example, 4 V.

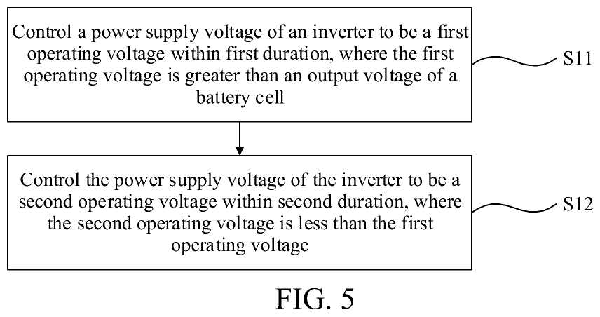

As shown in FIG. 5, this application further provides a control method for an electronic atomization apparatus. For the structure of the electronic atomization apparatus, reference may be made to the above content, and details are not described herein.

The method includes the following steps:
S11: Control a power supply voltage of an inverter to be a first operating voltage within first duration, where the first operating voltage is greater than an output voltage of a battery cell.
S12: Control the power supply voltage of the inverter to be a second operating voltage within second duration, where the second operating voltage is less than the first operating voltage.

It should be noted that, the above example is illustrated by an LCC series resonant circuit only. In other examples, the circuit may alternatively be an LC series resonant circuit (including but not limited to half-bridge series resonance and full-bridge series resonance), an LC parallel resonant circuit, or the like.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are provided for the purpose of providing a more thorough and comprehensive understanding of the content disclosed in this application. Moreover, the foregoing technical features are further combined to form various embodiments not listed above, and all such embodiments shall be construed as falling within the scope of the specification of this application. Further, a person of ordinary skill in the art may make improvements or modifications according to the foregoing description, and all the improvements and modifications shall fall within the protection scope of the appended claims of this application.

1. A control method for an electronic atomization apparatus, comprising:
a battery cell, configured to provide power;
an inverter, configured to generate a changing magnetic field; and
a susceptor, configured to be penetrated by the changing magnetic field to generate heat, so as to heat a liquid substrate to generate an aerosol; and
the method comprises:
controlling the battery cell to provide power to the inverter within at least one puff period, wherein the puff period is continuous and comprises first duration and second duration;
controlling a power supply voltage of the inverter to be a first operating voltage within the first duration, wherein the first operating voltage is greater than an output voltage of the battery cell; and
controlling the power supply voltage of the inverter to be a second operating voltage within the second duration, wherein the second operating voltage is less than the first operating voltage.

2. The method according to claim 1, wherein a starting time of the first duration is a time at which a puff indication signal is obtained.

3. The method according to claim 1, wherein the second duration is greater than the first duration.

4. The method according to claim 1, wherein the second duration starts at an end time of the first duration, and the second duration ends at an end time of the one puff.

5. The method according to claim 1, wherein the first duration ranges from 0.2 s to 1 s, or the first duration ranges from 0.3 s to 1 s, or the first duration ranges from 0.3 s to 0.8 s.

6. The method according to claim 1, wherein the electronic atomization apparatus further comprises a booster circuit for boosting a voltage of the battery cell; and
within the first duration, the booster circuit is controlled to operate to provide the first operating voltage.

7. The method according to claim 1, wherein within the second duration, the second operating voltage provided to the inverter is controlled to be the output voltage of the battery cell or close to the output voltage of the battery cell.

8. The method according to claim 1, wherein during the puff period, the power supply voltage of the inverter is controlled to be less than the first operating voltage within duration other than the first duration.

9. An electronic atomization apparatus, comprising:
a battery cell, configured to provide power;
an inverter, configured to generate a changing magnetic field;
a susceptor, configured to be penetrated by the changing magnetic field to generate heat, so as to heat a liquid substrate to generate an aerosol; and
a controller, configured to control the battery cell to provide power to the inverter within at least one puff period, wherein the puff period is continuous and comprises first duration and second duration; control a power supply voltage of the inverter to be a first operating voltage within the first duration, wherein the first operating voltage is greater than an output voltage of the battery cell; and control the power supply voltage of the inverter to be a second operating voltage within the second duration, wherein the second operating voltage is less than the first operating voltage.

10. The electronic atomization apparatus according to claim 9, wherein the inverter comprises a switching circuit and a resonant circuit; the switching circuit comprises switching transistors, and the resonant circuit comprises an inductor and capacitors; and
the switching transistors are configured to be alternately turned on and off under driving of a pulse signal, to cause an alternating current to flow through the inductor in the resonant circuit and generate a changing magnetic field.

11. The electronic atomization apparatus according to claim 10, wherein the inductors are connected in series to the capacitors.

12. The electronic atomization apparatus according to claim 11, wherein the switching transistors comprise a first switching transistor and a second switching transistor, and the capacitors comprise a first capacitor and a second capacitor;
the first switching transistor is connected in series to the second switching transistor to form a first branch, and the first capacitor is connected in series to the second capacitor to form a second branch; and
one end of the inductor is electrically connected between the first switching transistor and the second switching transistor, and the other end thereof is electrically connected between the first capacitor and the second capacitor.

13. The electronic atomization apparatus according to claim 11, wherein a resonant frequency of the inverter ranges from 800 KHz to 2 MHz.

14. The electronic atomization apparatus according to claim 9, wherein the electronic atomization apparatus comprises a power supply assembly and an atomizer removably connected to the power supply assembly,
wherein the battery cell, the inverter and the controller are all arranged in the power supply assembly; and the susceptor is arranged in the atomizer.

15. The electronic atomization apparatus according to claim 9, further comprising a sensor for detecting whether the electronic atomization apparatus is puffed to generate a puff indication signal.

16. The electronic atomization apparatus according to claim 9, further comprising a booster circuit for boosting a voltage of the battery cell, wherein
the controller is further configured to control the booster circuit to operate within the first duration to provide the first operating voltage.

17. The method according to claim 2, wherein the first duration ranges from 0.2 s to 1 s, or the first duration ranges from 0.3 s to 1 s, or the first duration ranges from 0.3 s to 0.8 s.

18. The method according to claim 3, wherein the first duration ranges from 0.2 s to 1 s, or the first duration ranges from 0.3 s to 1 s, or the first duration ranges from 0.3 s to 0.8 s.

19. The method according to claim 4, wherein the first duration ranges from 0.2 s to 1 s, or the first duration ranges from 0.3 s to 1 s, or the first duration ranges from 0.3 s to 0.8 s.
